(19) United States
(12) Patent Application Publication
(10) Pub. No.: US 2016/0276828 A1
(43) Pub. Date: Sep. 22, 2016

(54) Portable, Universal Direct Current (DC) Power Storage and Supply System

(71) Applicant: Paul Wilson Suggs, I, Hanahan, SC (US)

(72) Inventor: Paul Wilson Suggs, I, Hanahan, SC (US)

(21) Appl. No.: 15/045,226

(22) Filed: Feb. 16, 2016

Related U.S. Application Data
(60) Provisional application No. 62/176,349, filed on Feb. 13, 2015.

(51) Int. Cl. H02J 1/00; H02J 7/00

(52) U.S. Cl. CPC H02J 1/00; H02J 7/007

(57) ABSTRACT

A direct current power storage and supply system is disclosed to provide power for electronic equipment or electronic peripheral attachments to devices including powered sighting adjustments, including cameras, binoculars, hand-held or mounted weapons for hunting or military uses, including weapons' quickly rail mountable and detachable. Also, a universal DC power supply with quick-change batteries is disclosed. More particularly, the disclosed invention utilizes standard AA battery sizes and of varying chemical composition, to allow for quick replacement and/or recharging, depending on specific type of battery used.

(Reference is made to Provisional Application No. 62/176,349 filed Feb. 13, 2015, in anticipation of this Non-provisional application.)

### BACKGROUND

1. Field of the Invention

The disclosed invention relates to a quickly detachable, universal, containerized, direct current power storage and supply system of a size that can be mounted to a multiple devices for various purposes related to a need for a power supply. For example, there are multiple devices that may require small size power sources related to their use outdoors where a convenient delivered power outlet source is unavailable. Such devices may include power supply systems for powered sighting adjustments, which may include cameras, binoculars, hand-held or mounted weapons for hunting or military uses. Some military uses may involve weapons' features such as a Picatinny rail, Weaver rail, or similar mounting platforms for accessories mountings. More particularly, given possible outdoor applications, the invention is proposed for uses in all weather conditions. Thus, the invention has applications to photographers, as well as gun enthusiasts, including hunters and outdoorsmen generally, as well as military applications.

2. Description of the Prior Art

Previous to this invention the state of the art has not included a portable, universal, and mountable, direct current (DC) power supply that can connect to various devices including, but not limited to portable cameras (video and still), cellular smart phones, laser emitters and illuminating devices, as well as electronic rifle scopes and possible additional electronically powered rifle accessories. Related prior art related devices exhibit limited power capability and in some cases run out of power (therefore, becoming inoperable) while in a tactical or otherwise “use” environment. The disclosed invention is provided to increase the operating time of these devices (and possibly many other like and unlike devices that require electrical power in a miniature form or application). The invention has the potential not only of supplementing their power but in some cases replacing the need for them to have a primary power supply. The disclosed invention additionally reduces the amount of time and effort it takes to replace depleted battery cells. The invention provides the ability for a relatively easy battery swap that can be done very quickly in tactical and harsh environments without the need for tools. The invention's potential applications envisions the capacity for implementing additional features to include RF transmitters for the purpose of networking to share data and video, its own laser emitters and receivers, and illumination (beyond mere laser) capabilities.

### BRIEF DESCRIPTION OF THE INVENTION

While the invention offers the above-listed variety of applications, it is particularly believed to be the first of its kind to provide an appropriately sized and adequately durable capability for weapons' Picatinny rail quickly mountable and detachable, universal DC power supply with quick-change batteries. Former focus in this field of invention has been placed on 3 and 6 voltage direct current (VDC) variants with ranges of millimeter amperage hour's capacity. The disclosed invention conveniently can utilize standard AA battery sizes and of varying chemical composition, to allow for quick replacement and/or recharging, depending on type of battery used.

### BRIEF DESCRIPTION OF THE DRAWINGS

FIG. 1 is an exploded view of the primary components of the invention power supply device, showing their configurations and relative positions in making up the disclosed device. These primary components include the electronics core 1.1, the primary core 1.2, and the end cap 1.3.

FIG. 2 is a perspective view of the compressed version of FIG. 2 wherein the electronics core is brought into contact with its battery-supplied power source contained within primary core 1.2 housing and secured together by connector rods 1.3a affixing end cap 1.3.

### DETAILED DESCRIPTION OF THE INVENTION

The dimensions shown in the Figures are not limiting on the invention and are potentially scalable to the need, depending on the equipment to which it may be attached or with which it is used in conjunction. (A functioning prototype of the invention measures roughly 6 inches in length, 2-3 inches in height and 1-2 inches in depth, though within reasonable variables all elements of the device may be configurable based on application.)

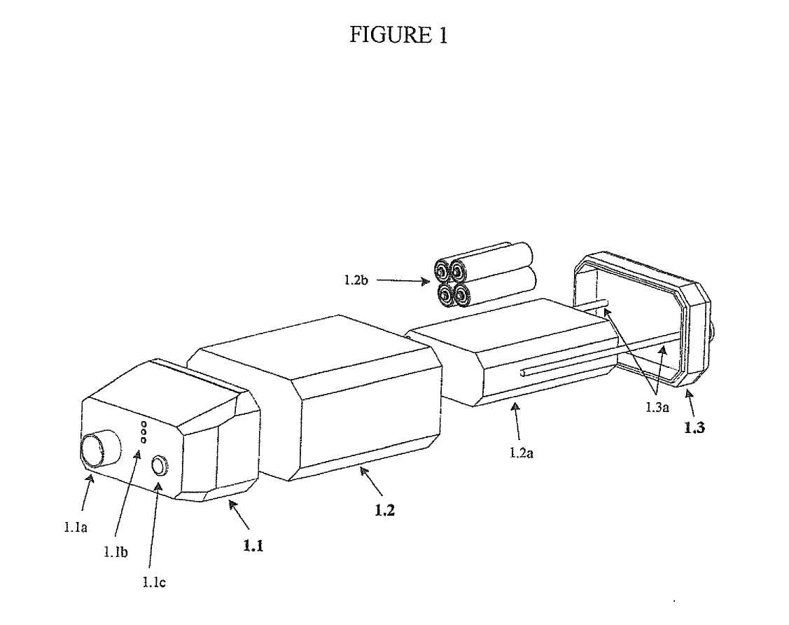

Referencing FIG. 1, the physical design includes: an electronics core (1.1) that holds all of the physical and electrical media and data transfer devices, as well as the charge controller electronics and short range wireless router components configurable to a myriad of commercial uses meeting Institute of Electronics and Electrical Engineers and Department of Defense frequency and protocol standards; a primary core cover (1.2), mostly for battery storage (both operating and backup), protection (from the environment) and access to said batteries; and, an end cap (1.3) for connecting, through the primary core cover 1.2, to the electronics core (1.1) for securing containment of the internals as further described below.

Specifically, connector 1.1a, which may include a singular (or multiple) connector(s) allow(s) a range including IP68/NEMA 5R environmental concerns, which ranges are configurable depending on need for a particular application. Such configurations include capability of powering externally Picatinny Rail-mounted (P4R) and NATO-rail mounted peripheral devices, including charging of a P4R device while in fully assembled mode of operations. The connection(s) permit transfer of both media and data through and up to pinned coaxial, tri-axial, fiber optic, and copper contacts.

Illuminated display 1.1b allows for easy viewing of the batter real time load status. This feature, though not necessary for functional operation, provides a user/operator valuable information regarding device “continued” operation. Said display indicates charging status, power on/off status, and displays data connection, sync and transfer statuses. Power switch 1.1c may function as power (on/off) only mode or, optionally, may function additionally as Mode status/indicator, depending on type of switch employed, e.g., button switch, flip switch, with or without light indication, etc. Based on the option employed, this feature may allow for easy viewing of battery real time load status, charging status, power status (i.e., on/off), as well as display data connection, sync and transfer statuses.

Continuing to reference FIG. 1, primary core cover 1.2 provides internal space therewithin to include enclosure 1.2a for operating battery, batteries, or a battery “pack” inclusive of multiple batteries (unshown, as they reside internal of enclosure 1.2a), as well as a remaining open area outside enclosure 1.2a but within primary core cover 1.2 sufficient to provide space for a backup battery, batteries, or battery pack 1.2b.

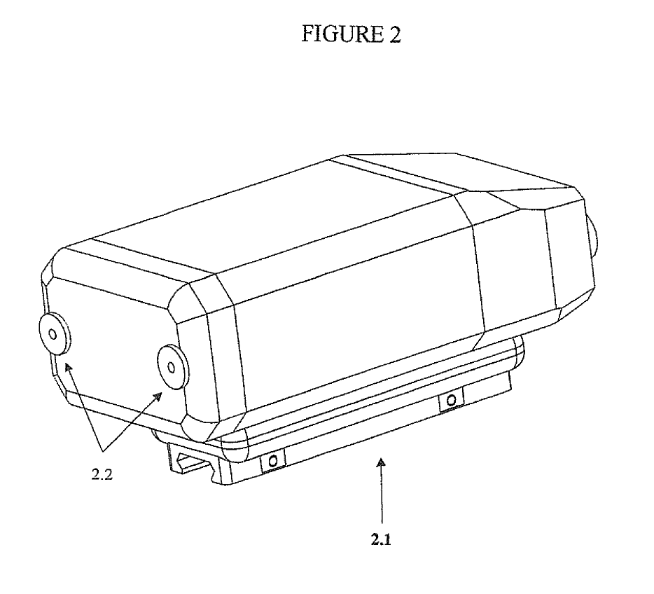

Finally, end cap 1.3 as shown in FIG. 1 includes connecting rods to secure said end cap 1.3, via the area within primary core cover 1.2, and to terminate in a securing means inside electronic core 1.1. Preferably, said rods are represented by screws that extend through the planar face of end cap 1.3 to be secured externally to the internal space of the electronics core 1.2 when FIG. 1 is collapsed from its exploded viewing version to the perspective shown in FIG. 2. Such securing is preferably accomplished by nuts secured at threaded ends of each of said connecting rods 1.3a. More preferably, said rods 1.3a are hardened, custom machined knurled head thumb screws that pass through end cap 1.3. It is necessary that the manner of passing the 1.3a through end cap 1.3 is configured in a manner to insure no water penetration within the disclosed invention device, given the potential for interference with the function of the device. Preferably, such insurance is accomplished by the use of at least one washer suitable for sealing against water penetration on a rod portion external to the end cap before applying any securing nut or nuts. More preferably, the washer will be constructed of natural rubber or a polymeric material. Most preferably, there is an array of gasket materials to provide for varying levels of water intrusion resistance, depending on the type device the power supply and system is used with.

The perspective view of the invention in FIG. 2 shows haw access to the internals is quickly and easily provided by removal of the shown outer cover of primary core 1.2, in this preferred embodiment, by unscrewing a knurled disc-like nuts 2.2 securing connecting rods 1.3a to allow removal of enc cap 1.3 for battery replacement in primary core 1.2 and access to an interior auxiliary electronics chamber in electronics core 1.1. FIG. 2 further depicts the slave rail mount mechanism 2.1 , which depicts a quick release Picatinny-, Nato-, Weaver-Rail mount. Such mount may include a “thumb and cam” lever with rail retaining bracket and knurled head bolts to join all mounting pieces together. The material construction is made up of either robust synthetics, metals, or a combination of both, which can be molded, extruded, printed, or machined. Design and functionality intent has been placed for users of the invention to be able to use this device in a varying degree of voltage options and is based upon best electronic industry practices dependent upon 3 and 6 voltage direct current (VDC) variants with varying millimeter amperage hour's capability. Utilizing standard AA battery sizes and batteries of varying chemical composition, to allow for quick replacement and or recharging depending on the type of battery used. Also, a wide variety of battery voltages may be employed. Such disclosed improved battery box is believed to represent the first of its kind in applications of battery storage and supply while mounted to the Picatinny Rail, Weaver Rail, or similar weapons and tactical mount systems.

The specific size of the invention device is variable depending on the equipment with which it is to be used.

Additional advantages and modification may readily occur to those skilled in the art. The invention in its broader aspects is, therefore, not limited to the specific details, representative apparatus, and illustrative examples shown and described. Accordingly, departures from such details may be made without departing from the spirit or scope of the applicant's general inventive concept.

What is claimed is:

1. A portable, universal direct current (DC) powered electrical supply source comprising a universal direct current power storage and supply system for uses for multiple devices.

2. The direct current power storage and supply system of claim 1 wherein the battery powered supply source comprises standard AA battery sizes and batteries of varying chemical composition.

3. The direct current power storage and supply system of claim 2 wherein the battery powered supply source is a portable, universal, and mountable, direct current (DC) power supply that can connect to multiple devices.

4. The direct current power storage and supply system of claim 3 wherein the multiple devices may be selected from the group consisting of electronic rifle scopes, video and still portable cameras, cellular smart phones, laser emitters and illuminating devices.

5. The direct current power storage and supply system of claim 4 wherein the portable, universal, and mountable, direct current (DC) power supply that can be mounted to the Picatinny, Weaver, or similar weapons and tactical mount systems.

6. The direct current power storage and supply system of claim 4 wherein the portable, universal, and mountable direct current (DC) power supply comprising:
(a) an electronics core comprising physical and electrical media and data transfer devices, charge controller electronics, and wireless router components a primary core;
(b) a primary core comprising a power source including at least one battery; and
(c) an end cap.

7. The direct current power storage and supply system of claim 6 wherein the electronics core includes:
(a) connectors for connecting the power source to the device to be powered,
(b) an illumination display, and
(c) means for monitoring the operational status of the direct current power storage and supply system selected from a power on/off switch and a mode status indicator.

8. The direct current power storage and supply system of claim 7 wherein the connectors are capable of
(a) powering externally from mounting locations on the group of mounting systems selected from a Picatinny Rail (P4R) and NATO Rail peripheral devices;
(b) charging of a P4R device while in fully assembled mode of operation;
(c) Transferring media and data through and up to contacts selected from the group selected from coaxial, tri-axial, fiber optic and copper contacts

9. The direct current power storage and supply system of claim 7 wherein the illumination display includes lighted monitoring of:
(a) Viewing of battery real time load status;
(b) Charging status;
(c) Power on/of status; and
(d) Data connection, sync and transfer statuses.

10. The direct current power storage and supply system of claim 7 wherein the means for monitoring the operational status of the direct current power storage and supply system includes:
(a) Power on/of status;
(b) Battery real time load status;
(c) Charging status; and
(d) Data connection, sync and transfer statuses.

11. The direct current power storage and supply system of claim 4 wherein the primary core comprises a housing located between the electronics core and the end cap which housing includes space within for an operational DC power source included in a separate smaller enclosure for power source in an operating mode and a remaining open area outside the power source enclosure, providing space for a backup DC power source also within the primary core housing.

12. The direct current power storage and supply system of claim 4 wherein the end cap is located at the opposite end of the storage and supply system from the connector core and comprises:
(a) A flat planar surface with a short wall extending up from the planar surface which wall is designed to connect with the bottom edge of the primary core housing to seal the power storage and supply system, and
(b) Multiple connecting rods extending from a secure connection within the electronics core and extending through holes in the end cap planar surface and secured there by securing means external to the end cap.

13. The direct current power storage and supply system of claim 12 wherein the connecting rods are threaded to permit matching threaded nuts to be the securing means.

14. The direct current power storage and supply system of claim 12 wherein the securing means is designed to include means to preclude water intrusion through the end cap holes.

15. The direct current power storage and supply system of claim 1 wherein the devices are selected from the group consisting of
